(19) United States
(12) Patent Application Publication
(10) Pub. No.: US 2026/0056862 A1
(43) Pub. Date: Feb. 26, 2026

(54) MODEL EVALUATION AND COMPARISON PLATFORM

(71) Applicant: Target Brands, Inc., Minneapolis, MN (US)

(72) Inventors: PUSHKAR CHENNU, San Francisco, CA (US); PRATHYUSHA KANMANTH REDDY, Richardson, TX (US); DAVID RELYEA, Seattle, WA (US)

(21) Appl. No.: 19/306,541

(22) Filed: Aug. 21, 2025

Related U.S. Application Data
(60) Provisional application No. 63/686,315, filed on Aug. 23, 2024.

(51) Int. Cl. G06F 11/34

(52) U.S. Cl. CPC G06F 11/3409

(57) ABSTRACT

A model assessment service is disclosed. The model assessment service may evaluate model metrics for an evaluation dataset using ground truth data and model predictions. The model assessment service may compare model performance by, among other things, comparing metric values against threshold values or against metric values of other models. Using a customizable configuration file, the model comparison may comprise different ways to compare models and different ways to evaluate specific metrics. As an example, the model assessment service can assess whether a new candidate model is to replace a deployed production model.

### CROSS-REFERENCE TO RELATED APPLICATIONS

The present application claims priority from U.S. Provisional Ser. No. 63/686,315 , filed on Aug. 23, 2024, the disclosure of which is hereby incorporated in its entirety.

### BACKGROUND

Developers of machine learning models often perform an iterative process of model development, training, tuning, and testing, ultimately moving a model that has adequate performance into a production environment for use. These model developers often maintain their own models, tests, and training data, as well as any sets of metrics that are required to prove performance of such models.

This arrangement has drawbacks. Often, multiple developers within an enterprise may be working on similar or related problems. Or a developer may not have enterprise-wide visibility into the specific performance issues required of the models being developed. Even in cases where such lack of communication does not exist, a common set of enterprise tests or evaluations of models prior to introduction into a production environment may be difficult to propagate to developers and/or enforce.

Furthermore, existing platforms do not provide a convenient mechanism by which models may be compared against one another or against those of a production environment to determine whether a newly developed model may exhibit superior performance to other candidate or baseline models.

### SUMMARY

In general terms, a model assessment service is disclosed. The model assessment service may evaluate and compare models. The model assessment service may evaluate model metrics for an evaluation dataset using ground truth data and model predictions. The model assessment service may compare model performance by, among other things, comparing metric values against threshold values or against metric values of other models. Using a customizable configuration file, the model comparison may include different ways to compare models and different ways to evaluate specific metrics. As an example, the model assessment service can assess whether a new candidate model is to replace a deployed production model.

In a first aspect, a platform useable to evaluate and compare a plurality of models is disclosed. The platform comprises a processor communicatively connected to a memory, the memory storing instructions which, when executed by the processor, cause the platform to perform: receiving a configuration file comprising an identification of a candidate model for evaluation, a first link to ground truth data, and a second link to prediction data, wherein the prediction data is generated by the candidate model performing inference using an evaluation dataset; using the ground truth data and the prediction data, determining a set of model metrics defining performance of the candidate model on the evaluation dataset; determining that, for a first metric of the set of model metrics, an absolute acceptability threshold is met; determining a weighted sum of at least some metrics of the set of model metrics for the candidate model; comparing the weighted sum to a second weighted sum associated with a reference model; and by comparing the weighted sum to the second weighted sum, determining that the candidate model is an optimal model from among the candidate model and the reference model.

In a second aspect, a method for assessing one or more models is disclosed. The method comprises receiving an identification of a candidate model for evaluation and an identification of an evaluation dataset to be used in association with the candidate model; determining a set of model metrics defining performance of the candidate model on the evaluation dataset using ground truth data for the evaluation dataset and prediction data generated by the candidate model; determining whether, for one or more model metrics of the set of model metrics, an absolute performance threshold is met; determining a weighted sum of at least some of the model metrics for the candidate model; comparing the weighted sum to one or more other weighted sums of the at least some of the model metrics associated with one or more models useable in the alternative to the candidate model; and by comparing the weighted sum to the one or more other weighted sums, determining an optimal model from among the candidate model and the one or more models useable in the alternative.

In a third aspect, a system is disclosed. The system comprises an application; and a model assessment service; wherein the application is configured to provide, to the model assessment service, a configuration file comprising an identification of a candidate model for evaluation and a set of model metrics; wherein the model assessment service is configured to: receive the configuration file; using ground truth data and prediction data generated by the candidate model, determine values for the set of model metrics; determine that, for a first metric of the set of model metrics, an absolute acceptability threshold is met; determine a weighted sum of at least some metrics of the set of model metrics for the candidate model; compare the weighted sum to a second weighted sum associated with a reference model; and by comparing the weighted sum to the second weighted sum, determine that the candidate model is an optimal model from among the candidate model and the reference model.

### BRIEF DESCRIPTION OF THE DRAWINGS

FIG. 1 illustrates an example network environment in which aspects of the present disclosure may be implemented.

FIG. 2 is a flowchart of an example method.

FIG. 3 illustrates a schematic diagram including the model evaluation system.

FIG. 4 illustrates an example configuration file received by the model evaluation system.

FIG. 5 illustrates example data processed by the model evaluation system.

FIG. 6 illustrates a schematic diagram including the model comparison system.

FIG. 7 illustrates an example configuration file received by the model comparison system.

FIG. 8 illustrates an example configuration file received by the model comparison system.

FIG. 9 is a flowchart of an example method for comparing one or more models.

FIG. 10 is a flowchart of an example method for comparing one or more models.

FIG. 11 illustrates an example output of the model assessment service.

FIG. 12 is a block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As briefly described above, embodiments of the present invention include a platform. The platform receives a structured object file defining one or more models, as well as one or more metrics and baseline performance characteristics of an acceptable model. The platform may receive an identification of a candidate model for evaluation, as well as an identification of an evaluation data set used in evaluating the candidate model. The platform may also receive metric data to be used in evaluating the candidate model. The metric data may include an identification of one or more metrics to be used in evaluating the model on the evaluation data set, as well as one or more thresholds at which a model used for a particular application may be considered acceptable, or successful. The platform may receive the identification of the candidate model alongside an identification of one or more other models, such as other candidate models, or a baseline model against which the candidate model is to be prepared.

The platform is configured to execute one or more tests on the candidate model and any other models against which it is to be compared, for example, using the evaluation data set. The platform computes a set of model metrics defining performance of the candidate model and the other models, including a set of predefined, standardized metrics, as well as optionally, one or more additional defined metrics specific to the application or model under test.

The model metrics may be defined in terms of key performance indicators (KPIs), which may be evaluated either individually or collectively to determine whether the model being evaluated satisfies an absolute performance threshold. An absolute acceptability threshold (AAT) may be a score selected from among one or more metrics (e.g., KPIs), or calculated as a score based on those KPIs, below which a model may be considered unacceptable for the evaluation data set. The absolute acceptability threshold may be set or customized in an input or configuration file used as part of a test executed by the platform. One or more absolute acceptability thresholds may be used, associated with multiple different tests. In some instances, the absolute acceptability threshold may be a minimum value, while in other instances the threshold may be a maximum value. Example absolute performance thresholds may include an accuracy threshold (e.g. set at 80%, or 0.8, or above), or a log loss threshold (e.g., set at 25-30%, or 0.3 or lower, in some instances).

The model metrics may also be defined to include a relative acceptable change (RAC). The relative acceptable change may be expressed as a percentage indicating the extent of change of a model metric between a new model and a reference model, such as a current production model. The relative acceptable change may be expressed as an upper limit or lower limit, and may be associated with similar types of performance analyses as considered in the absolute performance threshold (e.g., accuracy or loss metrics).

In some examples, the platform manages scheduling of execution of models to evaluate performance. The configuration file provided to the platform may define specific models for comparison, metrics, and a link to data used as an evaluation dataset. In other examples, a scheduling service may be used by the platform, with the scheduling service including information regarding a timing or recurrence of model evaluation. Accordingly, model designers may submit models and definitions of models to be tested at the platform, and the platform may manage testing models in conjunction with use of a job scheduler operable to assign predetermined schedule to ensure available resources for the model testing.

In some examples, the platform will calculate metrics that are numerical scores. Such numerical scores may correspond to a weighted sum across the set of some or all of the KPIs. The KPIs may include, for example, a hit rate, an accuracy of the model, other statistical performance measures (e.g., a least squares accuracy measurement). The weighted sum of KPIs may represent an overall score for the model performance associated with the evaluation data set. The weightings of KPIs may be adjusted and may differ depending on the perceived or organizational emphasis on particular indicators. For example, a false positive rate may be considered important, and assigned a higher weighting value, as compared to a false negative rate, or a ranking metric such as normalized discounted cumulative gain. In some embodiments, the weights across KPIs are the same. Other selected weightings and configurations of KPIs may be used as well. In examples, such weighting and configuration of KPIs may be defined in the configuration file, or the configuration file may define the specific model metrics obtained from the weighted KPIs, thereby making the testing and evaluation/comparison process highly customizable.

In some implementations, model evaluation outputs may be included in a structured (tabular) data, and may include an evaluation run date, a configuration used, and the like. Additionally, model comparison outputs may be generated, and may be stored as tabular data or in a structured data file (e.g., such as a JSON file); such model comparison outputs may include a summary of the comparison between models that is performed, as well as a set of metrics associated with evaluation of each model. Additionally, in some examples, a winner, or optimal, model is identified in the output file.

In the example implementations, to evaluate a given model, model metrics may be compared to absolute performance thresholds, as well as a relative acceptable change threshold between the currently evaluated model and one or more reference models similarly analyzed using the evaluation data set. Additionally, where two or more models are compared against each other, the weighted sum of model metrics for each model may be compared. Based on the weighted sum of model metrics for a candidate model being superior to that of another model, the model may be identified as an optimal model. Based on the model being identified as optimal, a report may be provided to the model developer or other interested individuals within an enterprise indicating the preferable model, as well as results of model evaluation. In some embodiments, once a developer reviews the performance of the model under evaluation relative to other models, that developer may deploy the preferable, or optimal model. This may be performed entirely separately from the platform, or may be deployed, either by the model developer, or automatically in response to determining that the model is in fact the optimal model.

Referring to the present disclosure generally, it is noted that a number of advantages are provided by the technology. For example, the platform may standardize metrics used across an enterprise for model evaluation, as well as provide a framework for approving models prior to those models being moved from a test environment into a production or deployment environment. Additionally, the platform may seamlessly integrate with a computing job scheduling system implemented within an enterprise, thereby enabling appropriate allocation of compute resources to model evaluation. Still further, the configuration file that is used to define model evaluation is highly flexible and adjustable by a user, such as a model developer, and, in some instances, includes aspects that are automatically generated to facilitate evaluation of models. This results in significant streamlining and risk mitigation of potential deployment of unreliable, unstable, or otherwise untested models relative to enterprise standards.

Additionally, aspects of the present disclosure provide a solution to the technical problem of inconsistent and unreliable model evaluation practices in machine learning development. For example, aspects of the present disclosure address the problem of model being deployed without adequate performance validation by providing a standardized framework that enforces consistent evaluation criteria through customizable configuration files that define absolute acceptability thresholds, relative acceptable change metrics, and weighted scoring systems. This standardization can reduce the risk of deploying unreliable, unstable, or underperforming models by ensuring all models meet benchmarks before production deployment.

Additionally, the technology addresses computational challenges in large-scale model evaluation through stage-based comparisons, batch processing, and memory management techniques. The platform processes evaluation data in configurable batches with vectorized operations, enabling efficient handling of datasets containing millions of entries while maintaining memory constraints and optimizing computational resources.

This approach allows organizations to evaluate models on massive datasets without overwhelming system resources, as the batch processing can be tuned based on available memory and computational capacity. Further, the system's model-agnostic design eliminates the need for specialized evaluation infrastructure for different model types, requiring, in some embodiments, only ground truth and prediction data regardless of the underlying model architecture.

Additionally, the technology provides model comparison capabilities that go beyond simple metric evaluation to enable optimal model selection through multiple comparison strategies. For example, the platform supports both round-robin comparisons among multiple candidate models and reference-based comparisons against baseline or production models, with each strategy employing different evaluation criteria including one or more of absolute thresholds, relative change limits, or weighted aggregate scoring. This multi-faceted approach ensures that model selection considers not only individual metric performance but also the relative improvement or degradation compared to existing systems, preventing deployment of models that may perform well in isolation but poorly relative to current production standards. Furthermore, the platform's support for custom metrics alongside standard library metrics enables incorporation of domain-specific evaluation criteria while maintaining the benefits of standardized evaluation infrastructure.

Advantageously, the system provides multiple ways to compare models to one another (e.g., round-robin and against-reference comparisons) and, within such comparisons, multiple ways to compare specific metrics (e.g., absolute acceptability thresholds, relative acceptable change thresholds, and aggregate scores). Moreover, the model evaluation system disclosed herein may be used to, for example, evaluate one or more models using one or more standard KPIs, define custom evaluation KPIs, or evaluate a same model using data from different periods. As will be apparent to those having ordinary skill in the art, these are only some of the advantages provided by aspects of the present disclosure.

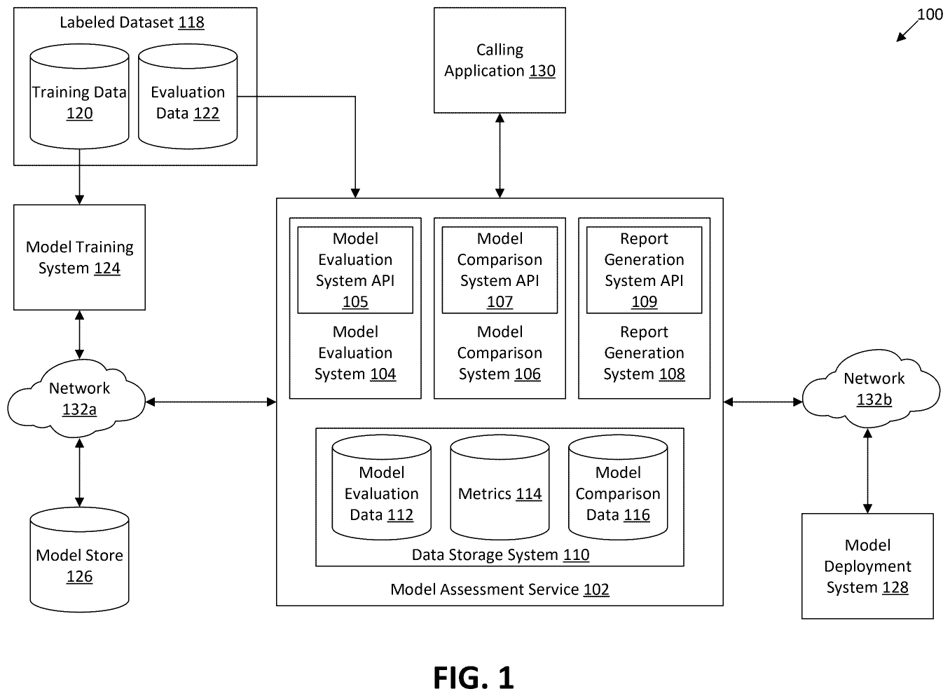

FIG. 1 illustrates a network environment 100 in which aspects of the present disclosure may be implemented. Components of the environment 100 can be part of an information system comprising a collection of software, hardware, networks, data, and people. The information system may be associated with an organization. For example, the organization may use, develop, maintain, own, or otherwise be associated with components of the environment 100. In some embodiments, the information system is associated with a retailer. Some components of the environment 100 may operate in a common computing environment. Some components of the environment 100 may operate in different computing environments and communicate over a network, such as the internet or a local network. Some components of the environment 100 may be developed and maintained by a third-party (e.g., an entity different than the organization with which the information system is associated). As shown, the environment may include, among other things, a model assessment service 102, a model training system 124, a model deployment system 128, and a calling application 130.

The model assessment service 102 includes software, hardware, or a combination thereof to assess one or more models. Assessing a model may include evaluating the model and comparing the model to one or more other models. The model assessment service 102 may include an interface via which applications can call the model assessment service 102. For example, the model assessment service 102 may include one or more application programming interfaces (APIs) via which an application can call one or more of the model evaluation system 104, model comparison system 106, or the report generation system 108.

In some embodiments, the model assessment service 102 is a distributable collection of software. For example, the model assessment service 102, or components thereof, may be a package that is integrated into other applications, such as the calling application 130. As an example, the model assessment service 102 may be a Python package, and as a result, may advantageously be seamlessly integrated into Python applications. In some embodiments, the model assessment service 102 is a standalone application. For example, the assessment service 102 may be executed on a server and client applications, such as the calling application 130, may call one or more APIs exposed by the model assessment service 102 or by components thereof. In some embodiments, the model assessment service 102 is integrated with a scheduler system, such that the model assessment service 102 is triggered as part of a sequence of predefined steps or workflow, such as a sequence of steps for evaluating a new, or retrained model, or as part of a sequence of steps for assessing a model prior to deployment.

In some embodiments, the model assessment service 102 is accessed and utilized in an offline environment. As an example, a model developer may download the model assessment service 102 and use it offline during model development. Advantageously, such offline model assessment may enable faster model experimentation and iteration without impacting live, online systems. In some embodiments, the model assessment service 102 is deployed in an on-premises server system. In some embodiments, the model assessment service 102 is cloud based, such that the model assessment service 102 may be deployed in a private, public, or hybrid cloud.

In the example shown, the model assessment service 102 includes a model evaluation system 104, a model comparison system 106, a report generation system 108, and a data storage system 110. In some embodiments, one or more of the model evaluation system 104, the model comparison system 106, or the report generation system 108 is a sub-service or a microservice associated with the model assessment service 102. In some embodiments, the model assessment service 102 includes an orchestrator that coordinates execution of one or more of the model evaluation system 104, the model comparison system 106, or the report generation system 108.

One or more of the model evaluation system 104, the model comparison system 106, or the report generation system 108 can include an API to access the respective component, as shown in the example of FIG. 1 by the model evaluation system API 105, the model comparison system API 107, and the report generation system API 109. Each of the APIs 105, 107, 109 may provide a standardized format for calling each respective component, such that, even if the model assessment service 102 is utilized across different applications or environments, the data format for calling the components may be standardized, thereby advantageously improving the ease of use of the model assessment service 102 and extending its utilization across further applications. In some embodiments, one or more of the APIs 105, 107, or 109 may be part of a unified API layer of the model assessment service 102. In some embodiments, one or more of the APIs 105, 107, or 109 may be individually called by the calling application 130, thereby providing control to the calling application 130 regarding which components of the model assessment service 102 to utilize.

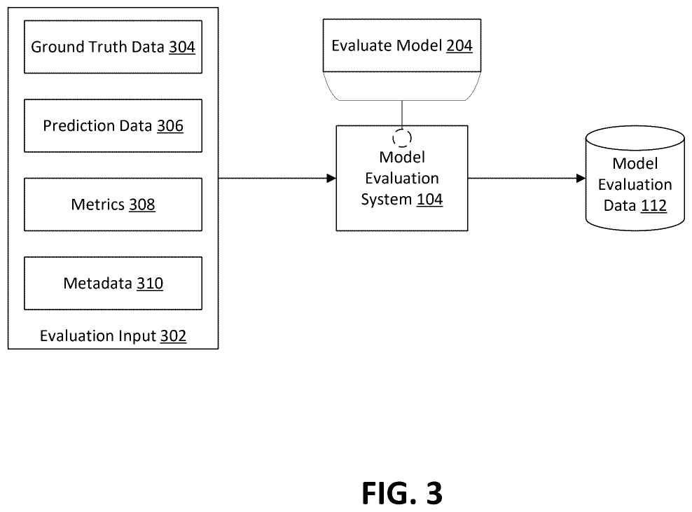

The model evaluation system 104 can evaluate performance of a model. For example, the model evaluation system 104 evaluates one or more metrics of the metrics 114 for the model's performance on a set of evaluation data 122. Example operations and features of the model evaluation system 104 are further described in connection with FIGS. 3-5.

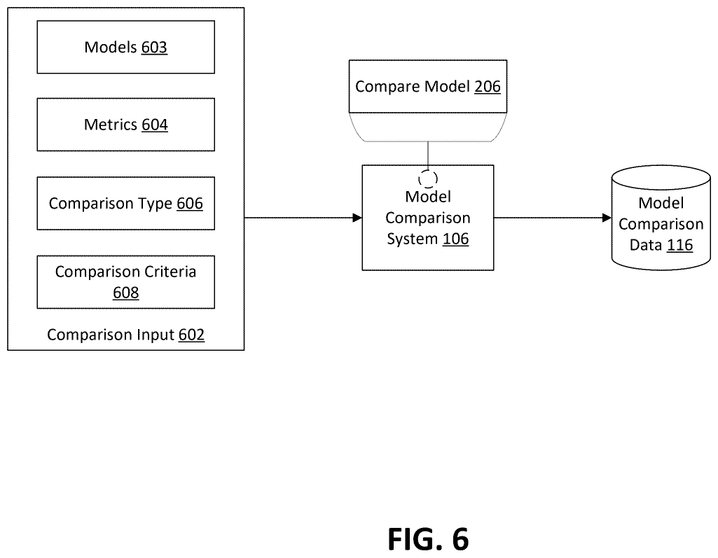

The model comparison system 106 can compare the performance of a model to the performance of one or more other models. For example, model comparison system 106 can compare metric values generated by the model evaluation system 104 for a first model to metric values generated by the model evaluation system 104 for a model useable in the alternative, which may be referred to as a reference model, a current production model, or another model. Example operations and features of the model comparison system 106 are further described in connection with FIGS. 6-11.

The report generation system 108 can generate a report regarding an evaluation of a model or a comparison of a model to one or more other models. The report can include visualizations of data generated by one or more of the model evaluation system 104 or the model comparison system 106.

The data storage system 110 may include various components for storing and managing data. For example, the data storage system 110 may include storage devices, which provide physical space for data; interfaces that connect the storage devices to other devices; and storage management software, which handles tasks like data organization, access control, and ensuring data integrity. In some embodiments, the data storage system 110 includes one or more query engines for retrieving data from datasets stored in databases.

The model evaluation data 112 may include data that is received, generated, or processed by the model evaluation system 104. For example, the model evaluation system 104 may, for a given model, compare model predictions with ground truth values for a given dataset. The comparisons may be performed pursuant to one or more metrics, such as the metrics defined in the metrics 114. The results of such a comparison may be part of the evaluation data 112. For instance, if one of the metrics to be evaluated is the normalized discounted cumulative gain, then one or more values for the normalized discounted cumulative gain determined by the model evaluation system 104 in view of model prediction data and ground truth data can be stored in the model evaluation data 112. Likewise, values for other metrics input into the model evaluation system 104 may be determined and stored in the model evaluation data 112.

Each stored record in the model evaluation data 112 may include metadata such as model identifiers, source identifiers, data identifiers, evaluation timestamps, metric parameters, and the computed metric values, enabling traceability and historical tracking of model performance over time. The persistent storage provided by model evaluation data 112 enables subsequent retrieval and comparison of model performance results, supporting downstream processes such as model comparison, performance monitoring, and automated deployment decision-making. By advantageously storing results in this way, at a later time after the comparison, the performance of the given model for the given evaluation can be quickly retrieved to, for example, compare that model's performance against the performance of a new or different model.

The metrics 114 include the evaluation metrics to be evaluated by the model evaluation system 104. In some embodiments, calculating values for the metrics includes comparing model prediction data with ground truth data for a common evaluation dataset, such as data of the evaluation data 122 of the labeled data set 118. In some embodiments, the metrics 114 are pre-defined metrics that may be selected for evaluation by applications using the model assessment service 102. Non-limiting examples of metrics of the metrics 114 include the following: accuracy score, precision score, recall score, f1 score, classification report, confusion matrix, roc auc score, log loss, hinge loss, mean squared error, mean absolute error, mean squared log error, median absolute error, r2 score, explained variance score, adjusted rand score, adjusted mutual info score, normalized mutual info score, homogeneity score, completeness score, v measure score, average precision score, precision recall curve, roc curve, zero one loss, hamming loss, jaccard score, pairwise distances, variations of one or more of these metrics, combinations of one or more of these metrics, or other metrics. In some embodiments, one or more of the metrics 114 includes customized metrics. In some embodiments, certain metrics of the metrics 114 may require arguments that can be input by a user of the model assessment service 102.

The model comparison data 116 includes data that is received, generated, or processed by the model comparison system 106. For example, when the model comparison system 106 compares a model evaluation result, such as metric values generated by the model evaluation system 104, against a threshold value or against a model evaluation result from a different model, the model comparison system 106 can generate a result of this comparison and store that result in the model comparison data 116. Accordingly, the model comparison data 116 may include, for example, relative comparisons of model performance against other model performance or results of comparing model metrics against absolute acceptability thresholds. In some embodiments, a comparison record stored in the model comparison data 116 includes metadata such as comparison run timestamps, configuration file references, comparison strategy types, and metric values for evaluated models, thereby advantageously ensuring traceability and reproducibility of comparison decisions. The storage architecture of the model comparison data 116 may support hierarchical organization of comparison results, with separate sections for different comparison strategies (round-robin and against-reference) and individual comparison outcomes within each strategy, enabling users to easily navigate and analyze results from complex multi-strategy evaluation runs. The model comparison data 116 can enable downstream processes including automated deployment decision-making, performance monitoring over time, or historical analysis of model selection decisions, thereby improving a broader model lifecycle management infrastructure.

The labeled data 118 includes data in which each sample is paired with a corresponding output or label. Each labeled instance consists of the data itself, such as a vector of features representing real-world entities or events, and the target value, which may be a class identifier in classification tasks or a continuous value in regression tasks. In the retail context, for example, the labeled data may include data associated with a customer at a retail website and the label may be an action taken by the customer, such as a purchase or selection action. As another example, the labeled data set 118 may include time series demand data, where the label may be the amount of demand and the sample may include data associated with context surrounding that demand, such as a time of year, a location, an item, and the like. In some embodiments, the labeled data 118 includes historical data. For example, the labeled data 118 may include historical user activity at a website or on a mobile application.

In the example shown, the labeled dataset 118 may be partitioned into training data 120 and evaluation data 122. The training data 120 may be used to train models, such as by the model training system 124. For example, the labeled training data 120 may be used in a supervised training process to train the models.

The evaluation data 122 may be used to evaluate a model once it has been trained. For example, the evaluation data 122 may remain unseen during training to provide an unbiased estimate of model performance. The labels of the evaluation data 122 may correspond to the ground truth values for the evaluation data 122. Once a model has been trained, the model may be used to predict the labels of the evaluation data 122, or a particular dataset thereof. The model evaluation system 104 may compare the predicted values for the evaluation data 122 with the ground truth labels.

As an example in the retail context, there may be data for a historical six-month period. The data may be, for example, six previous months of customer purchase data. This data may be partitioned into training data 120 and evaluation data 122. The evaluation data 122 may be the last N days (e.g., where N ranges from 1 to 7), and the training data 120 may be the remaining data of the six-month data. Once a model trained to predict purchase data has been trained on the training data, it can attempt to predict the purchase data for the N days that were withheld as part of the evaluation data 122.

The model training system 124 can train models using the training data 120. Examples of such models are described in connection with the model store 126. In some embodiments, the training system 124 can include a software and hardware infrastructure that performs a process of training the models, encompassing data ingestion, preprocessing, model initialization, backward propagation, gradient computation, and parameter updates using optimization algorithms. In some embodiments, the training system 124 only performs a subset of the operations required to train the models. For example, the training system 124 may, in some embodiments, fine-tune the models, which may include a pre-trained base model. The training system may apply distributed and parallel computation across CPUs, GPUs, or TPUs, and may include software frameworks like TensorFlow or PyTorch. Furthermore, the training system 124 can incorporate mechanisms for checkpointing, logging, hyperparameter tuning, and resource management. Furthermore, the training system 124 can include components for data sharding, pipeline optimization, memory management, and fault tolerance to ensure scalability and robustness during large-scale or long-duration training runs. For different models of the models, the training system 124 can use different training processes or different training data. In some embodiments, once a model is trained, it may be stored in the model store 126.

The model store 126 may be a repository that manages the storage, versioning, and retrieval of models throughout their lifecycle. It may facilitate reproducibility, deployment, and collaboration by maintaining metadata such as model parameters, training context, evaluation metrics, and lineage. In some embodiments, the model store 126 is centralized. Alternatively, it can be distributed, with models stored across multiple environments or regions. Examples of models that may be assessed by the model assessment service 102, one or more of which may be trained by the model training system 124 or stored by the model store 126, include the following: linear regression, logistic regression, ridge regression, lasso regression, decision trees, random forests, support vector machines, k-nearest neighbors, naive Bayes, gradient boosting machines, XGBoost, neural networks, convolutional neural networks, recurrent neural networks, long short-term memory networks, transformer models, autoencoders, variational autoencoders, generative adversarial networks, graph neural networks. clustering models, hidden Markov models, Bayesian networks, or other types of models.

The model deployment system 128 is a combination of hardware and software that deploys models, such as one or more of the models described in connection with the model training system 124 or the model store 126. The model deployment system 128 makes the models available for inference and may expose endpoints through which the deployed models may be called. In some embodiments, the model deployment system 128 can deploy models so that they can be called by a retail application, such as a retail website or mobile application.

The calling application 130 is an application that may call or otherwise use the model assessment service 102 or a component thereof. In some embodiments, the calling application 130 is a Python application used by a model developer. In some embodiments, the calling application 130 is a workflow coordination application that regularly calls the model assessment service 102 as part of another process, such as a pre-defined process for developing or deploying models. In some embodiments, the calling application 130 can integrate the model assessment service 102, or components thereof, into the calling application 130 as a software package. In such embodiments, the calling application 130 may advantageously use the model assessment service 102 in an offline environment. Although shown as a single component in the example of FIG. 1, there may be a plurality of applications that call the model assessment service 102. In some embodiments, the calling application 130 may call the model assessment service 102 over a network. For example, in the case where the model assessment service 102 is deployed in a cloud environment, the calling application 130 may call the model assessment service 102 over a network.

The networks 132a-b may communicatively couple components of the network environment 100. Each of the networks 132a-b may be, for example, a wireless network, a wired network, a virtual network, the internet, or another type of network. Furthermore, the networks 132a-b may include subnetworks, and the subnetworks may be different types of networks or the same type of network.

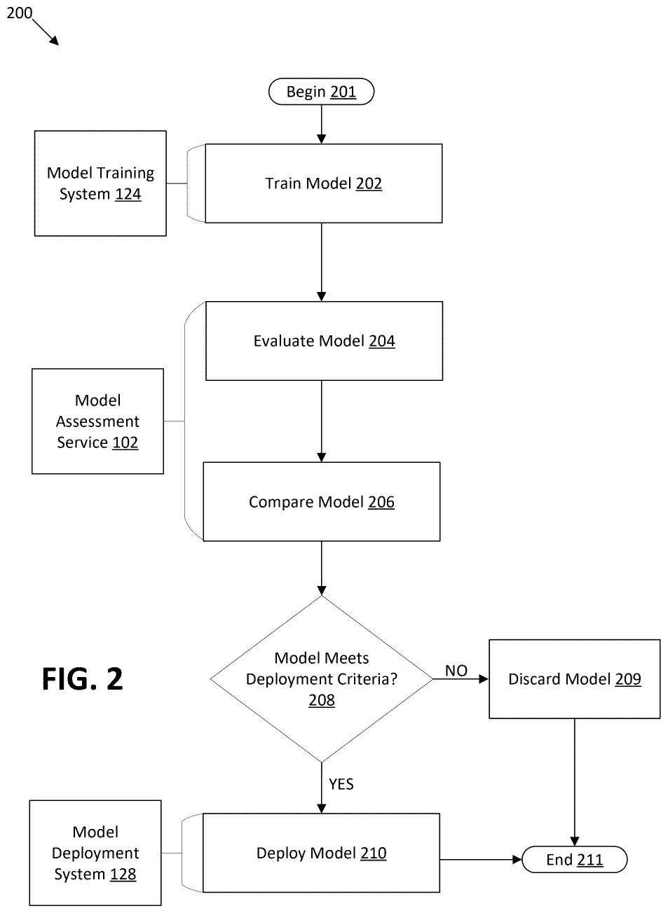

FIG. 2 is a flowchart of an example method 200. Components of the environment 100 may perform operations of the method 200. Although FIG. 2 is described as being performed for an example model, operations of the method 200 may be performed for a plurality of models. The example model may be, for example, one of the models described in connection with the model store 126. In some embodiments, the operations of the method 200 are performed automatically one after another, such as part of an automated training, assessment, and deployment workflow. Advantageously, however, not all operations of the method 200 need to be performed during a same time or session but may be repeated or performed at different times. For example, at a first time, a model may be evaluated, and its evaluation results stored. Then a later time, such as after a new model has been developed or when a frontend application is ready to use the model, the model may be compared to other models and assessed for whether it is to be deployed.

In the example shown, the model training system 124 may train the model (step 202). For example, the model training system 124 may train the model using the training data 120, example aspects of which are described in connection with FIG. 1. Once trained, the model can be validated or evaluated on a test, or evaluation, data set, such as the evaluation data 122. In some embodiments, such validation or evaluation is performed by the model training system 124 or component communicatively coupled therewith. In some embodiments, the validation or evaluation is performed by the model evaluation system 104.

In the example shown, the model assessment service 102 may evaluate the model (step 204). For example, the model evaluation system 104 may evaluate the model, example aspects of which are further described in connection with FIG. 3.

In the example shown, the model assessment service 102 may compare the model (step 206). For example, the model comparison system 106 may compare the model to one or more other models, example aspects of which are further described in connection with FIG. 6. In some embodiments, the model comparison is performed automatically following performance of model evaluation. For example, the calling application 130 may make a single call to the model assessment service 102, providing one or more configuration files, and thereby triggering performance of each of model evaluation and model comparison.

In the example shown, it may be determined whether the model meets deployment criteria (step 208). Advantageously, the deployment criteria may be customizable. For example, a model may be deployed based on results of the model comparison operation. For example, if a model is a winner of a comparison, then the model may be selected for deployment. For example, if the model meets an absolute acceptability threshold, meets a relative acceptable change threshold, outperforms another model, or a combination thereof, for one metric or for a combination of metrics, then it may be determined that the model is to be deployed. As an example, if a new model outperforms a model that is currently deployed for one or more metrics, and if the model meets threshold absolute values for one or more other metrics, then that model may be deployed in place of the current production model.

The model assessment service 102, the model deployment system 128, or another component may perform the operation 208. In response to determining that the model meets the deployment criteria (taking the “YES” branch), then the operation 200 may proceed to the step 210. In response to determining that the model does not meet the deployment criteria (taking the “NO” branch), then the operation 200 may proceed to the step 209.

In the example shown, if the model does not meet the deployment criteria, then the model may be discarded (step 209). Discarding the model may include discarding it from consideration for being deployed during a current iteration, but the model may be stored in the model store 126. Additionally, discarding the model may include erasing it from the model store 126.

In the example shown, if the model meets the deployment criteria, then the model may be deployed (step 210). Example aspects of deploying the model are further described in connection with model deployment system 128. The method 200 may end (step 211) after performance of the step 209 or step 210

FIG. 3 illustrates an example diagram including the model evaluation system 104. FIG. 3 includes an evaluation input 302, the model evaluation system 104, and the evaluation data 112. In some embodiments, the model evaluation system 104 receives, as an input, an input file comprising ground truth data, prediction data, metrics to compute, and metadata, and the model evaluation system 104 may output computed metrics defined by the metrics 308. The output may be stored in the evaluation data 112.

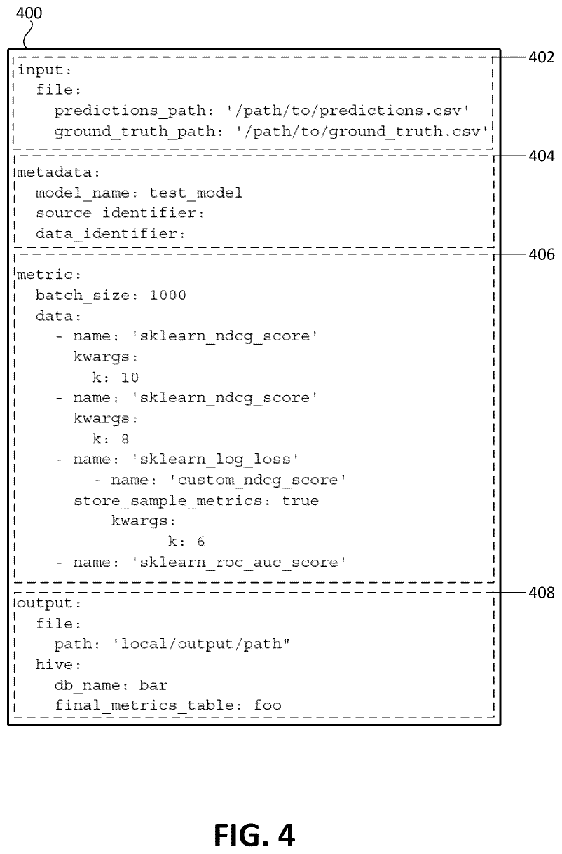

The evaluation input 302 can include inputs to the model evaluation system 104. One or more of the inputs in the evaluation input 302 may be provided by the calling application 130. The evaluation input 302 may include one or more of ground truth data 304, prediction data 306, metrics 308, and metadata 310. In some embodiments, the evaluation input 302 is a configuration file that includes one or more of the inputs 304-310 or includes a reference or link to the one or more of the inputs 302. An example of the evaluation input is shown by the configuration file 400 of FIG. 4.

The ground truth data 304 may be ground truth values for an evaluation dataset, and the prediction data 306 may be predicted values for that evaluation dataset. For example, a model that is being evaluated by the model evaluation system 104 may, having been trained, generate predictions for the evaluation dataset. Examples of such an example dataset are described in connection with the evaluation data 122.

Advantageously, in some embodiments, the model evaluation system 104 is model agnostic. For example, if the model evaluation system 104 receives the ground truth data 304 and the prediction data 306 then it does not matter what type of model is being evaluated.

For example, the ground truth data 304 may represent the actual, verified outcomes or labels for an evaluation dataset that serves as the benchmark against which model predictions are measured. This data includes labeled instances where each sample is paired with its corresponding correct output or target value, such as class identifiers in classification tasks or continuous values in regression tasks. In the retail context, for example, the ground truth data 304 may include historical customer purchase data where the labels represent actual actions taken by customers, such as purchase decisions or product selections. The ground truth data 304 may be derived from historical data that has been partitioned from a larger labeled dataset, remaining unseen during the model training process to provide an unbiased estimate of model performance. The format of the ground truth data 304 may be a CSV file containing the verified outcomes, or a link to such as a CSV file, and it must have the same number of entries as the corresponding prediction data 306 to ensure proper alignment for evaluation purposes.

The prediction data 306 comprises the output values generated by a trained model when performing inference on the same evaluation dataset for which ground truth data 304 exists. This data is produced after a model has completed its training phase and is applied to predict outcomes for the evaluation dataset, representing the model's best estimates or classifications based on its learned parameters. The prediction process involves using the trained model to make predictions on the test dataset, with the results typically saved in CSV format for processing by the model evaluation system 104.

The metrics 308 define the specific evaluation criteria and performance measures that will be calculated by the model evaluation system 104. The metrics 308 may include one or more of the metrics 114. The metrics 308 can include one or more pre-defined evaluation measures such as accuracy score, precision score, recall score, f1 score, ROC AUC score, log loss, mean squared error, and normalized discounted cumulative gain, as well as custom-defined metrics tailored to specific applications. One or more of the metrics 308 may be configured with parameters or keyword arguments, which may be included in the evaluation input 302, such as setting the value of ‘k’ for NDCG calculations or specifying normalization parameters, allowing for fine-tuned evaluation based on the particular needs of the model assessment. The metrics 308 may also specify computational parameters such as batch size. For example, the model evaluation system 104 may process the ground truth data 304 and the prediction data 306 in chunks based on the received batch size to improve memory utilization and performance.

The metadata 310 contains identifying or contextual information about the model evaluation process. The metadata 310 may include, for example, the model name, source identifier, and data identifier. Advantageously, such data may enable traceability and reproducibility of the evaluation results and enable retrieval and use of the model evaluation results at a later time. The model name serves as a user-defined identifier for the specific model being evaluated, while the source identifier may correspond to a git commit hash or other version control identifier that uniquely identifies the source code used to generate the model. The data identifier may combine information about the evaluation dataset, including the ground truth file name and its creation timestamp, creating a unique identifier for the specific dataset used in the evaluation process. When used as part of an automated workflow, the metadata 310 can be automatically populated by the system, with the source identifier mapped to a lookup table containing model information and training data sources, and the data identifier mapped to a table containing dataset information and file creation details.

The model evaluation system 104 may receive the evaluation input 302 and evaluate the model (step 204) by comparing prediction data 306 against ground truth data 304 using the metrics 308. In some embodiments, the model evaluation system 104 may process the input data in configurable batches, with each batch containing a specified number of samples (e.g., 10,000) that are evaluated using vectorized operations for computational efficiency and memory management. For each batch, the model evaluation system 104 may calculate individual sample-level metrics by comparing each prediction against its corresponding ground truth value, then aggregate these sample metrics to produce batch-level performance measures using aggregation operations such as mean calculations. After processing all batches, the model evaluation system 104 may perform a final aggregation step to compute dataset-level metrics that represent the overall model performance across the evaluation dataset with which the ground truth data 304 and the prediction data 306 are associated.

As a result, the model evaluation system 104 may, in some embodiments, generate model evaluation data that includes sample-level, batch-level, and aggregate performance measures of one or more metrics for the model on the evaluation dataset.

The model evaluation system 104 may store this data in the model evaluation data 112. Moreover, other data that is received by the model evaluation system 104 (e.g., the evaluation input 302) or other data processed by the model evaluation system 104 may also be stored in the model evaluation data 112.

FIG. 4 illustrates an example configuration file 400. The configuration file 400 is an example of the evaluation input 302.

The configuration file 400 includes an input section 402. The input section 402 includes a link to prediction data, as described in connection with the prediction data 306, and a link to ground truth data, as described in connection with the ground truth data 304. The configuration file 400 further includes a metadata section 404 that may include metadata described in connection with the metadata 310. The configuration file 400 includes a metrics section 406 that may include data described in connection with the metrics 308. The configuration file 400 may further include an outputs section 408, which may specify where the results of the evaluation are to be stored.

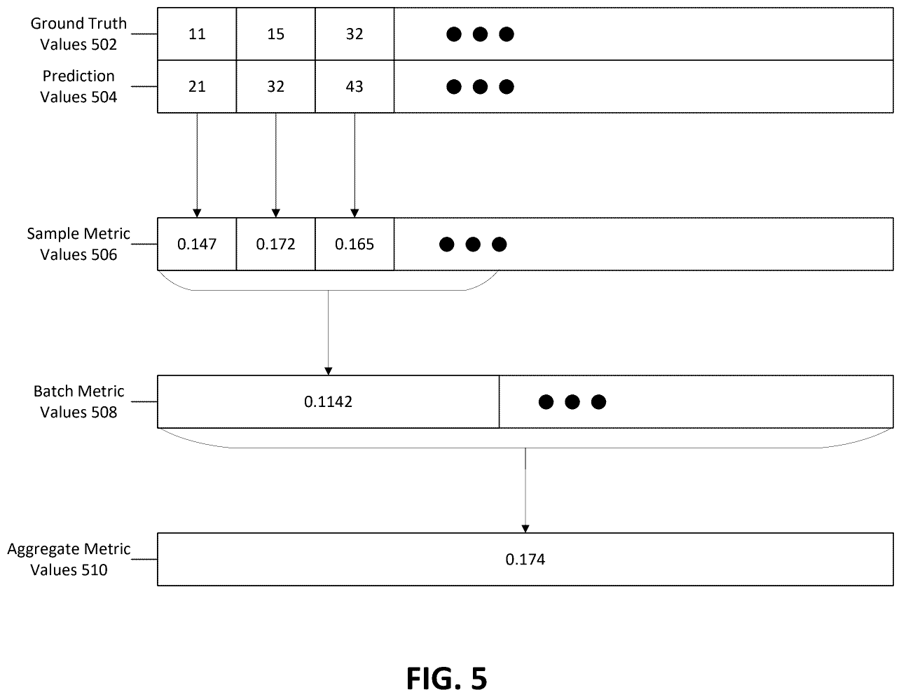

FIG. 5 illustrates a schematic diagram of portions of an example evaluation performed by the model evaluation system 104. The example evaluation shown in FIG. 5 may correspond to a specific metric identified in the metrics 308 or to a combination of metrics in the metrics 308.

The ground truth values 502 include actual outcomes for a sample evaluation dataset, shown here as discrete numerical values (e.g., 11, 15, 32, etc.). The ground truth values 502 are examples of the ground truth data 304 described in connection with FIG. 3. In this example, the ground truth values 502 demonstrate an example evaluation scenario where each data point has a corresponding true value that will be compared against the model's predictions to determine metrics.

The prediction values 504 include outputs generated by the model being evaluated when applied to the same evaluation dataset samples, shown as numerical values (e.g., 21, 32, 43, etc.). The prediction values 504 are examples of the prediction data 306 described in connection with FIG. 3. These predictions may be produced through the inference process where the model processes the input features and generates outputs according to its trained parameters.

The sample metric values 506 represent individual performance scores calculated for corresponding pairs of ground truth and prediction values, shown as values (e.g., 0.147, 0.172, 0.165, etc.) that quantify the model's accuracy or error for samples. These sample-level metrics are computed using the evaluation functions specified in the metrics configuration, such as absolute error, squared error, or custom distance measures, depending on the type of model and the specified metric 308. In some embodiments, this granular level of metric calculation is particularly valuable for custom metrics where users may want to analyze the distribution of performance across individual samples or identify specific patterns in model behavior.

The batch metric values 508 represent aggregated performance measures for groups of sample metrics, shown here as a value that summarizes the model's performance across a batch of evaluation samples. These values are calculated by applying aggregation operations to the sample metric values 506 within each processing batch, providing an intermediate level of performance assessment between individual samples and the entire evaluation dataset. The batch-level aggregation may provide various advantages including memory management during large-scale evaluations, enabling parallel processing of evaluation data, and providing intermediate checkpoints for monitoring evaluation progress.

The aggregate metric values 510 represent the dataset-level performance score that summarizes the model's effectiveness across the evaluation dataset for a metric. This value may be determined by aggregating all batch metric values 508 using statistical operations such as weighted averages or simple means, depending on the specific metric and evaluation requirements. The aggregate metric values 510 may be used as performance indicators used for model comparison, deployment evaluation, and performance monitoring, providing a single numerical summary of model quality that can be easily compared across different models or evaluation runs.

FIG. 6 illustrates an example diagram including the model comparison system 106. FIG. 6 includes a comparison input 602, the model comparison system 106, and the model comparison data 116. In some embodiments, the model comparison system 106 receives, as an input, an input file comprising metrics to be compared, comparison types, and criteria for the comparisons. Using the comparison input 602, the model comparison system 106 compares performance data for a model against one or more threshold values or performance of other models, and outputs results of the comparison to the model comparison data 116.

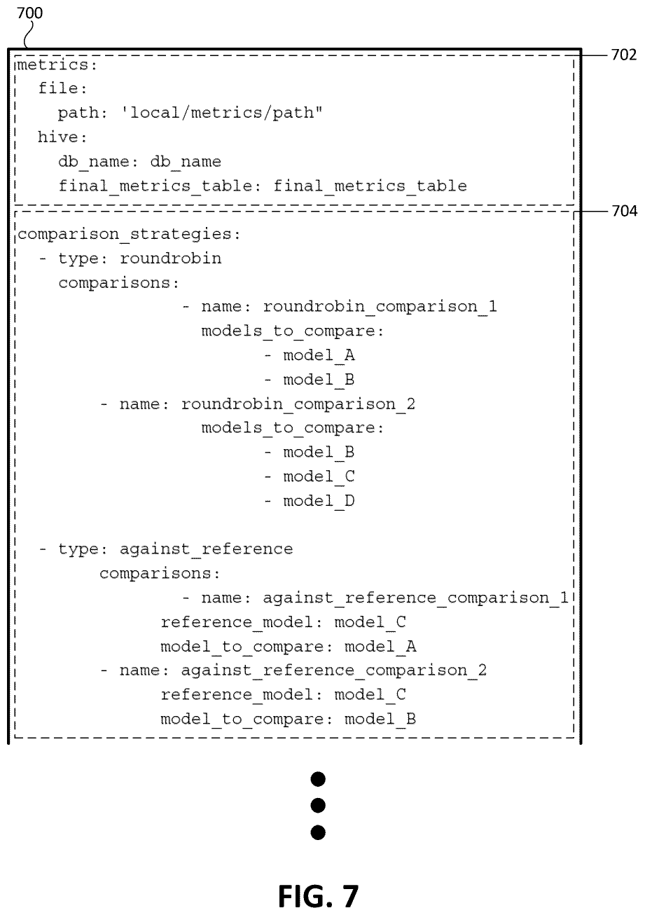

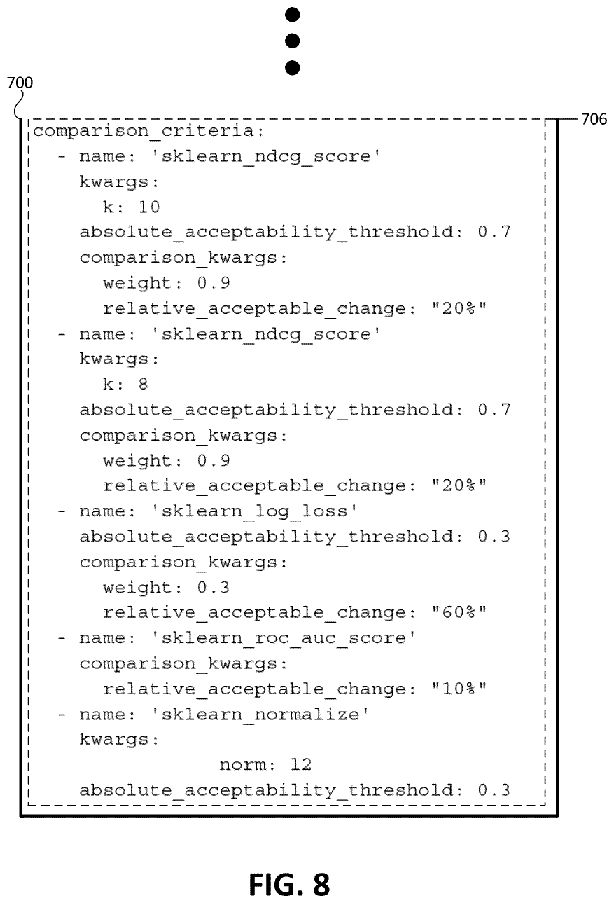

The comparison input 602 can include inputs to the model comparison system 106. One or more of the inputs in the comparison input 602 may be provided by the calling application 130. In some embodiments, the comparison input 602 is a configuration file that includes one or more of the inputs 603-608 or includes a reference or link to the one or more of the inputs. The comparison input 602 may be structured to accommodate both local development environments where metrics are stored in local files, and enterprise production environments utilizing distributed data storage systems. An example of the comaparison input is shown by the configuration file 700 of FIGS. 7-8. The configuration format may enable flexible specification of multiple comparison strategies within a single evaluation run, allowing users to perform both round-robin comparisons among multiple candidate models and reference-based comparisons against baseline or production models simultaneously.

The models 603 can identify one or more models to be compared. The models 603 may include an identifier of or a link to the one or more models. In some embodiments, the models 603 includes a single model. For example, the models 603 may include a single model that is to be compared against one or more threshold values. In other embodiments, the models 603 includes multiple models that may be compared against one another. The metric values of the metrics 604 may have been generated by the models 603. Data in the comparison type 606 and comparison criteria 608 can refer to the models 603.

The metrics 604 may represent the metric values generated by the model evaluation system 104 for each model being compared. Example metric types of the metrics 604 are described in connection with the metrics 114, and example aspects of generating values for these metrics are described in connection with FIG. 3. The metrics 604 may be a link to a data store including the metrics. In the data store, the metrics 604 may be organized by model identifier and metric type, with each data entry containing the specific metric name, any associated parameters (such as ‘k’ values for top-k metrics), and the computed numerical value representing the model's performance on that particular measure. The metrics 604 can be sourced from either local file systems during development phases or from distributed data storage systems in production environments, with the model comparison system 106 automatically handling data retrieval and formatting for comparison operations.

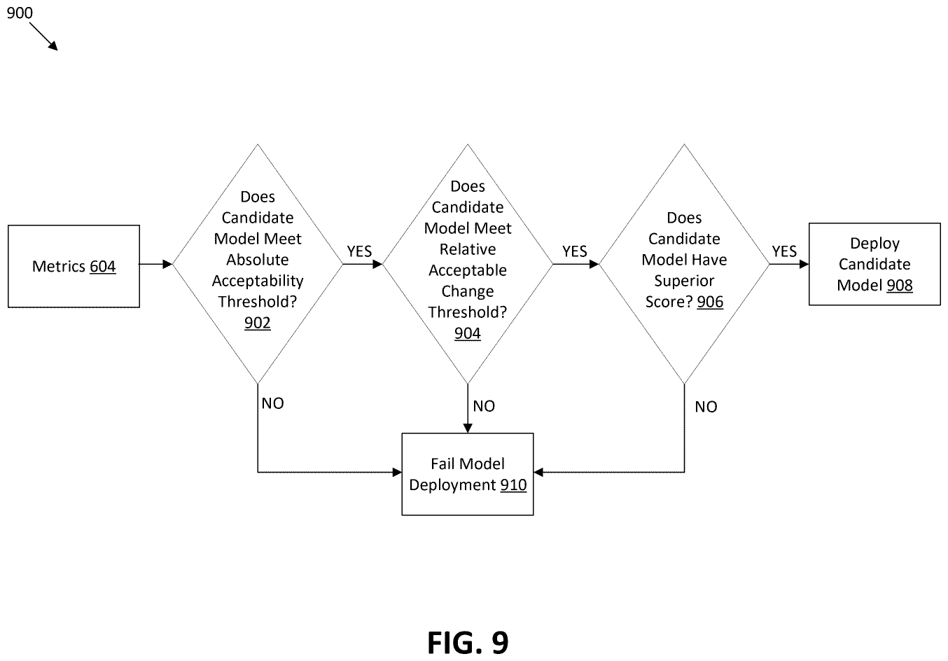

The comparison type 606 defines the type of comparison to be used for comparing models. In some embodiments, the comparison type may be a round-robin comparison, an against-reference comparison, or both. A round-robin comparison may include comparing multiple candidate models against each other, where each model is compared to other models in the specified group to identify the best-performing model for the metrics 604 based on the comparison criteria 608. Advantageously, the round-robin strategy can enable multiple independent comparison groups within a single evaluation run, allowing users to define separate comparisons such as comparing models A and B in one group while simultaneously comparing models B, C, and D in another group, with each comparison yielding its own winner based on the specified criteria. Example aspects of a round-robin comparison are described in connection with FIG. 9.

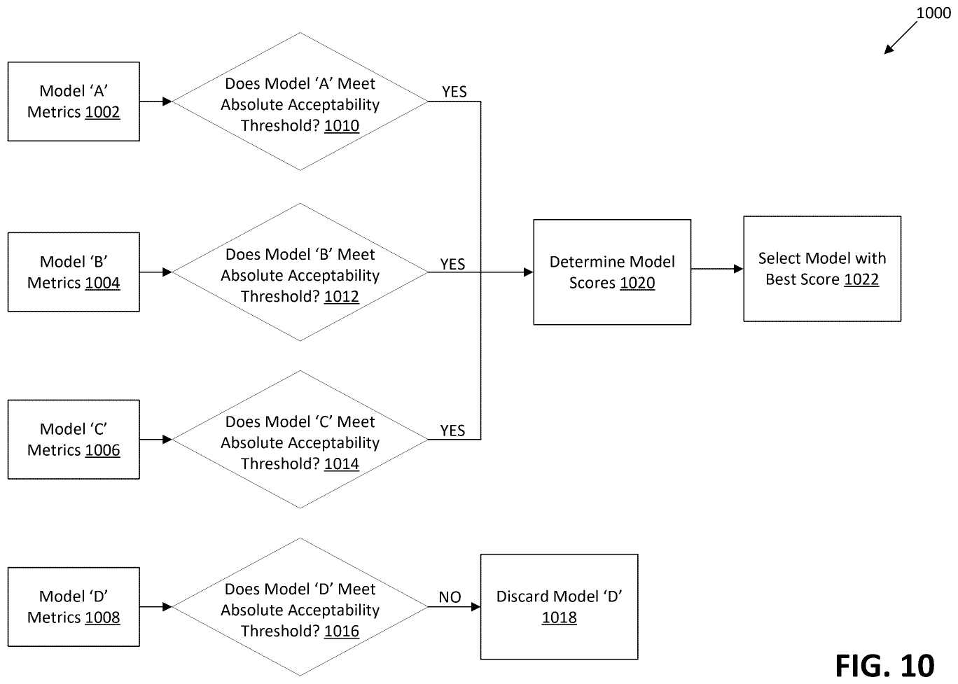

An against-reference comparison can provide a threshold comparison where one or more candidate models are compared against a designated reference model, such as a current production model, enabling users to determine whether new models represent improvements over existing deployed solutions. Example aspects of an against-reference comparison are described in connection with FIG. 10. The comparison type 606 configuration allows users to specify multiple comparison strategies within a single evaluation run, enabling comprehensive model assessment that includes both peer-to-peer comparisons among candidate models and performance validation against established baselines, thereby supporting complex model selection workflows.

The comparison criteria 608 can include evaluation standards applied to metrics, such as the metrics 604, during model comparison operations. The comparison criteria 608 may include absolute acceptability thresholds (AAT), relative acceptable change (RAC) values, weighted combinations thereof, or other evaluation standards. An absolute acceptability threshold establishes minimum or maximum performance standards that a model being compared must meet, with the model comparison system 106 automatically determining whether higher or lower values are preferable based on the metric type (e.g., accuracy must exceed 0.8 for higher-is-better metrics, while log loss must remain below 0.3 for lower-is-better metrics).

A relative acceptable change value may be used to compare a new model's performance against a reference model using percentage-based thresholds, allowing acceptable performance degradation within specified limits (e.g., permitting up to 20% decrease in accuracy or 10% increase in log loss) while ensuring that improvements in any direction are always acceptable. A weighted scoring system in the comparison criteria 608 enables multi-metric evaluation by assigning weights to different metrics and computing aggregate scores. Advantageously, the comparison criteria 608 also supports flexible metric inclusion, allowing users to specify which metrics participate in absolute threshold testing, relative change evaluation, or weighted scoring, thereby enabling customized evaluation strategies.

The model comparison system 106 receives the comparison input and compares the one or more models pursuant to the comparison input 602 (step 206). For example, the model comparison system 106 can compare the metrics 604 of the models 603 according to the specified comparison type 606 and comparison criteria 608.

For round-robin comparisons, the model comparison system 106 can test each model against absolute acceptability thresholds for the metrics. In some embodiments, any model failing these baseline requirements is disqualified from further consideration. In some instances, if the model fails to meet the absolute acceptability threshold for any of the metrics being evaluated for an absolute acceptability threshold, then it is disqualified from the round robin. The model comparison system 106 may then calculate weighted scores for all models that have not been disqualified by applying the specified weights to their respective metric values. The model comparison system 106 may then compare the weighted scores for the models and select a model having the best score, as described further in connection with FIG. 10.

For against-reference comparisons, the model comparison system 106 may compare a first model against a second model. For example, the model comparison system 106 may compare a candidate model against a reference model, which may be a current production model. In some embodiments, such a comparison may include evaluating one or more of an absolute acceptability threshold, a relative acceptability threshold, or a weighted aggregation score. As an example, the model comparison system 106 may perform a three-stage evaluation process: first validating that candidate models meet absolute acceptability thresholds, next assessing whether the performance changes relative to the reference model fall within acceptable limits as defined by the relative acceptable change parameters, and next comparing weighted scores between candidate and reference models to determine the optimal choice. In some embodiments, the model comparison system 106 generates comparison results that include winner identification, and metric and comparison breakdowns for the evaluated models.

The model comparison system 106 can store results of the model comparison (step 206) in the model comparison data 116. Further, the model comparison system 106 may store other data received by the model comparison system 106, such as the comparison input 602 and data thereof, or processed by the model comparison system 106 in the model comparison data 116.

FIGS. 7-8 illustrate an example configuration file 700. The configuration file 700 is an example of the comparison input 602. The configuration file 700 begins on FIG. 7 and continues to FIG. 8.

The configuration file 700 includes a metrics section 702. The metrics section 702 includes a reference to the metric values to be evaluated, as described in connection with the metrics 604 of FIG. 6. For example, the metrics section 702 can include a location of a local metrics file or to a database storing the metrics. The configuration file 700 further includes a comparison strategies section 704. The comparison strategies section 704 may indicate one or more types of comparisons to be performed and the models to be compared. Example aspects of the comparison strategies section 704 are described in connection with the comparison types 606 of FIG. 6. The comparison criteria 608 includes metrics to be compared, thresholds associated with the metrics, and weights associated with the metrics. Example aspects of the comparison criteria 706 are described in connection with the comparison criteria 608 of FIG. 6.

FIG. 9-10 illustrate example comparisons that may be performed by the model comparison system 106, providing examples of the operations of the model comparison system 106 described in FIG. 6. FIG. 9 illustrates an example of a comparison of a candidate model against a reference model, such as a comparison of a model that could be deployed with a model that is currently deployed. FIG. 10 illustrates an example of a round-robin comparison, in which a plurality of models are evaluated against one another. In the example of FIG. 10, one of the compared models may or may not be a currently deployed model.

FIG. 9 illustrates an example method 900. Operations of the method 900 may be performed by the model comparison system 106.

In the example shown, the model comparison system 106 receives the metrics 604. For example, the model comparison system 106 may receive a comparison input 602, and the comparison type 606 may indicate that an against-reference comparison is to be performed. For example, a candidate model is to be compared against a reference model. The metrics 604 may include the metric values for the candidate model and the reference model.

In the example shown, the model comparison system 106 performs multiple comparisons across the steps 902-906. For each comparison, the model comparison system 106 compares the metrics that are specified (e.g., in the comparison input 602) for that comparison. For example, if two metrics are configured to be compared for an absolute acceptability threshold comparison, then those two metrics may be evaluated for that test. Moreover, one or more different metrics, or the same metrics, may be evaluated during a relative acceptable change assessment or a weighted score assessment.

In the example shown, the model comparison system 106 determines whether the candidate model meets the absolute acceptability thresholds for the specified metrics (step 902). In some embodiments, if any metric for the candidate model fails this criteria, the model comparison system 106 rejects the candidate model and the method 900 proceeds to step 910.

In the example shown, the model comparison system 106 determines whether the candidate model meets the relative acceptable change thresholds when compared to the reference model (step 904). For example, the relative acceptable change is expressed as a percentage indicating the extent of acceptable change between the new model and current production model, allowing acceptable performance degradation within specified limits while ensuring that improvements in any direction are always acceptable. If a metric for the candidate model falls outside the bounds of the specified relative acceptable change, then the model comparison system 106 rejects the candidate model and the method 900 proceeds to step 910.

In the example shown, the model comparison system 106 determines whether the candidate model has a higher score than the reference model (step 906). Or if the metrics being evaluated are superior when lower, then the model comparison system 106 determines whether the candidate model has a lower score than the reference model. This score may be a weighted score of the specified metrics. For example, the weighted scoring enables multi-metric evaluation by assigning weights to different metrics and computing aggregate scores, with the model comparison system 106 calculating weighted scores for the candidate and reference models by applying specified weights to their respective metric values. This comparison determines whether the candidate model outperforms the reference model based on the comprehensive weighted evaluation of all configured metrics. If the reference model has a superior score relative to the candidate model, then the model comparison system 106 rejects the candidate model, and the method 900 proceeds to the step 910.

If the candidate model successfully passes all three evaluation stages (AAT, RAC, and weighted score comparison), the model comparison system 106 proceeds to step 908 where the candidate model replaces the reference model. This represents a successful model deployment scenario where the new model demonstrates superior performance. Example aspects of model deployment are described in connection with the model deployment system 128 of FIG. 1. Conversely, if the candidate model fails any of the three evaluation stages, the system proceeds to step 910 where model deployment fails, and the candidate model is rejected. Advantageously, by employing this multi-step comparison of the method 900, the model comparison system 106 can quickly fail models that do not meet minimum acceptability thresholds for any given metric and proceed to further compare models for which minimum performance has been established.

FIG. 10 illustrates an example method 1000. Operations of the method 1000 may be performed by the model comparison system 106. In the example of FIG. 10, the models to be compared are Model ‘A’, Model ‘B’, Model ‘C’, and Model ‘D’. One of these models may be a currently deployed model and be considered a reference model.

The others may be considered candidate models. In some embodiments, none of these models are a currently deployed model. As will be understood, more or fewer models can be compared using the operations of FIG. 10.

In the example shown, the model comparison system 106 receives the metrics for the models to be compared. For example, the model comparison system 106 receives Model ‘A’ metrics 1002, Model ‘B’ metrics 1004, Model ‘C’ metrics 1006, and Model ‘D’ metrics 1008 as part of the metrics 604. For example, the model comparison system 106 may receive a comparison input 602, and the comparison type 606 may indicate that a round-robin comparison is to be performed.

In the example shown, the model comparison system 106 can evaluate each model against one or more configured absolute acceptability thresholds at the steps 1010-1016, which may be performed sequentially or in parallel. For example, for all metrics for which an absolute acceptability threshold was configured, the model comparison system 106 may compare the model's metric value with the configured threshold to determine if the model meets baseline performance requirements. If any metric for a model fails this criteria, that model is disqualified from further consideration, as demonstrated by Model ‘D’ proceeding to step 1018 where it is discarded from consideration.

In the example shown, models that successfully pass the AAT evaluation proceed to determine scores for the models (step 1020). For example, for all metrics for which a weight was given, the model comparison system 106 can determine a weighted score for each qualifying model by factoring in metrics and their respective weights, applying specified weights to their respective metric values. The round-robin strategy enables robust model assessment by comparing weighted scores among qualifying models, with whichever model having passed the AAT requirements and possessing the best weighted score being judged as the optimal model.

In the example shown, the model comparison system 106 selects the model with the best score (step 1022). For example, the model comparison system 106 determines the winning model based on the best score determined at the step 1020 among all models that met the absolute acceptability thresholds. Depending on the metrics being evaluated, the best score may be the highest weighted score or the lowest weighted score. In some embodiments, the selected model may then be deployed by the model deployment system 128. This approach advantageously allows users to define separate comparisons and enables multiple independent comparison groups within a single evaluation run.

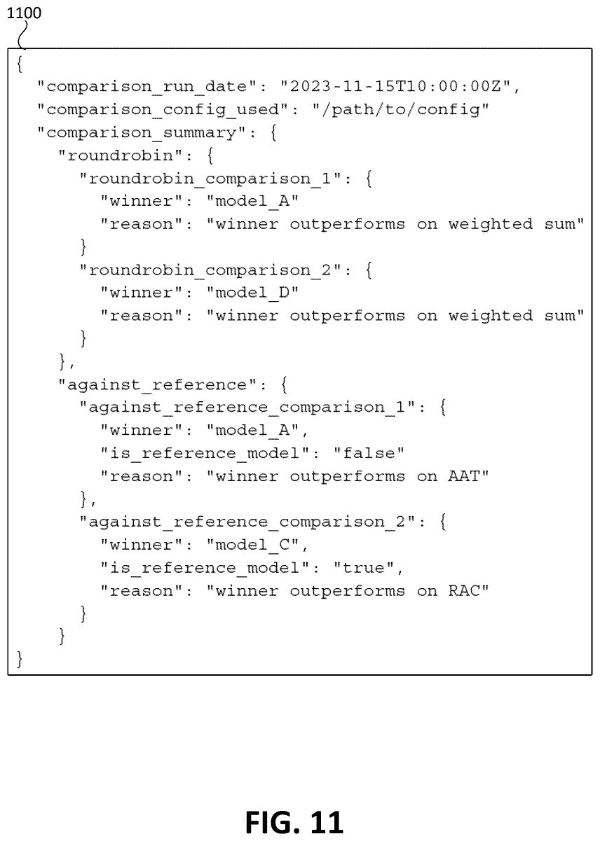

FIG. 11 illustrates an example report 1100. The report 1100 is an example report output by the model assessment service 102 or by the model comparison system 106 specifically. The report includes data of a comparison performed by the model comparison system 106. As shown, the report 1100 includes metadata regarding the comparison, such as a comparison date and a configuration file used. Further, the report 1100 includes a summary of the specific comparisons performed, including, for a given comparison, the type of comparison, the selected model from the comparison, and a reason for which the model comparison system 106 selected the winning model. In some embodiments, the report 1100 is stored in the model comparison data 116.

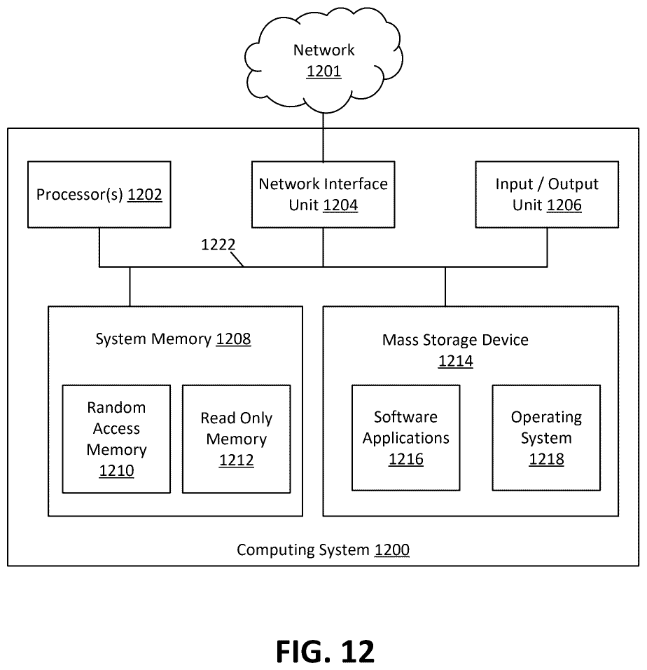

FIG. 12 illustrates an example block diagram of a virtual or physical computing system 1200. One or more aspects of the computing system 1200 can be used to implement computing systems and processes described herein.

In the embodiment shown, the computing system 1200 includes one or more processors 1202, a system memory 1208, and a system bus 1222 that couples the system memory 1208 to the one or more processors 1202. The system memory 1208 includes RAM (Random Access Memory) 1210 and ROM (Read-Only Memory) 1212. A basic input/output system that contains the basic routines that help to transfer information between elements within the computing system 1200, such as during startup, is stored in the ROM 1212. The computing system 1200 further includes a mass storage device 1214. The mass storage device 1214 is able to store software instructions and data. The one or more processors 1202 can be one or more central processing units or other processors.

The mass storage device 1214 is connected to the one or more processors 1202 through a mass storage controller (not shown) connected to the system bus 1222.

The mass storage device 1214 and its associated computer-readable data storage media provide non-volatile, non-transitory storage for the computing system 1200. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the computing system 1200 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1200.

According to various embodiments of the invention, the computing system 1200 may operate in a networked environment using logical connections to remote network devices through the network 1201. The network 1201 is a computer network, such as an enterprise intranet and/or the Internet. The network 1201 can include a LAN, a Wide Area Network (WAN), the internet, wireless transmission mediums, wired transmission mediums, other networks, and combinations thereof. The computing system 1200 may connect to the network 1201 through a network interface unit 1204 connected to the system bus 1222. It should be appreciated that the network interface unit 1204 may also be utilized to connect to other types of networks and remote computing systems. The computing system 1200 also includes an input/output controller 1206 for receiving and processing input from a number of other devices, including a touch user interface display screen, or another type of input device. Similarly, the input/output controller 1206 may provide output to a touch user interface display screen or other type of output device.

As mentioned briefly above, the mass storage device 1214 and the RAM 1210 of the computing system 1200 can store software instructions and data. The software instructions include an operating system 1218 suitable for controlling the operation of the computing system 1200. The mass storage device 1214 and/or the RAM 1210 also store software instructions, that when executed by the one or more processors 1202, cause one or more of the systems, devices, or components described herein to provide functionality described herein. For example, the mass storage device 1214 and/or the RAM 1210 can store software instructions that, when executed by the one or more processors 1202, cause the computing system 1200 to receive and execute managing network access control and build system processes.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, operations can be accomplished via one or more sub-operations. Further, operations described herein, although described as being performed by a component, can be performed by one or more different components. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A platform useable to evaluate and compare a plurality of models, the platform comprising:
a processor communicatively connected to a memory, the memory storing instructions which, when executed by the processor, cause the platform to perform:
receiving a configuration file comprising an identification of a candidate model for evaluation, a first link to ground truth data, and a second link to prediction data, wherein the prediction data is generated by the candidate model performing inference using an evaluation dataset;
using the ground truth data and the prediction data, determining a set of model metrics defining performance of the candidate model on the evaluation dataset;
determining that, for a first metric of the set of model metrics, an absolute acceptability threshold is met;
determining a weighted sum of at least some metrics of the set of model metrics for the candidate model;
comparing the weighted sum to a second weighted sum associated with a reference model; and
by comparing the weighted sum to the second weighted sum, determining that the candidate model is an optimal model from among the candidate model and the reference model.

2. The platform of claim 1, wherein the reference model is a current production model.

3. The platform of claim 1, wherein the candidate model and the reference model are new models.

4. The platform of claim 1, wherein the reference model corresponds to a baseline model.

5. The platform of claim 1, wherein the instructions further cause the platform to perform determining that, for a second metric of the set of model metrics, a relative acceptable change threshold is met.

6. The platform of claim 5, wherein determining the weighted sum of the at least some metrics of the set of model metrics for the candidate model and comparing the weighted sum to the second weighted sum are only performed in response to determining that the absolute acceptability threshold is met and that the relative acceptable change threshold is met.

7. The platform of claim 1, wherein the configuration file further comprises an identification of the first metric, the absolute acceptability threshold, and weights for determining the weighted sum.

8. The platform of claim 1, wherein the candidate model is in a test environment within an enterprise.

9. A method for assessing one or more models, the method comprising:
receiving an identification of a candidate model for evaluation and an identification of an evaluation dataset to be used in association with the candidate model;
determining a set of model metrics defining performance of the candidate model on the evaluation dataset using ground truth data for the evaluation dataset and prediction data generated by the candidate model;
determining whether, for one or more model metrics of the set of model metrics, an absolute performance threshold is met;
determining a weighted sum of at least some of the model metrics for the candidate model;
comparing the weighted sum to one or more other weighted sums of the at least some of the model metrics associated with one or more models useable in the alternative to the candidate model; and
by comparing the weighted sum to the one or more other weighted sums, determining an optimal model from among the candidate model and the one or more models useable in the alternative.

10. The method of claim 9, further comprising, in response to determining the optimal model, deploying the optimal model to a production environment.

11. The method of claim 9, further comprising receiving a configuration file comprising the identification of the candidate model for evaluation and the identification of the evaluation dataset.

12. The method of claim 9, wherein determining the set of model metrics comprises, for a model metric of the set of model metrics:
determining differences between samples in the ground truth data and the prediction data for the samples; and
aggregating the differences to generate an aggregate metric value for the model metric.

13. The method of claim 9, further comprising:
receiving an identification of a second candidate model;
determining a set of model metrics defining performance of the second candidate model on the evaluation dataset using the ground truth data for the evaluation dataset and prediction data generated by the second candidate model; and
discarding the second candidate model from consideration in response to determining that, for the one or more model metrics of the set of model metrics, the absolute performance threshold is not met.

14. The method of claim 9, wherein comparing the weighted sum to the one or more other weighted sums is performed offline.

15. A system comprising:
an application; and
a model assessment service;
wherein the application is configured to provide, to the model assessment service, a configuration file comprising an identification of a candidate model for evaluation and a set of model metrics;
wherein the model assessment service is configured to:
receive the configuration file;
using ground truth data and prediction data generated by the candidate model, determine values for the set of model metrics;
determine that, for a first metric of the set of model metrics, an absolute acceptability threshold is met;
determine a weighted sum of at least some metrics of the set of model metrics for the candidate model;
compare the weighted sum to a second weighted sum associated with a reference model; and
by comparing the weighted sum to the second weighted sum, determine that the candidate model is an optimal model from among the candidate model and the reference model.

16. The system of claim 15, wherein the model assessment service comprises a software package integrated into the application.

17. The system of claim 15, wherein the model assessment service is a cloud service.

18. The system of claim 15, wherein the model assessment service is further configured to determine that, for a second metric of the set of model metrics, a relative acceptable change threshold is met.

19. The system of claim 18, wherein the relative acceptable change threshold is a percentage of a value of the second metric associated with the reference model.

20. The system of claim 15, wherein the model assessment service is further configured to provide, to the application, a structured output indicating that the candidate model is the optimal model from among the candidate model and the reference model.
